(19) United States
(12) Patent Application Publication
(10) Pub. No.: US 2007/0105563 A1
(43) Pub. Date: May 10, 2007

(54) Apparatus and method for controlling call admission in an orthogonal frequency division multiplexing mobile communication system

(75) Inventors: Jung-Min Ro, Seoul (KR); Eun-Taek Lim, Suwon-si (KR); Young-Bin Chang, Anyang-si (KR); Jae-Hyuk Jang, Deagu (KR); Dong-Seek Park, Yongin-si (KR); Young-Kwon Cho, Suwon-si (KR); Joon-Young Choi, Suwon-si (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/585,466

(22) Filed: Oct. 24, 2006

(30) Foreign Application Priority Data
Oct. 24, 2005 (KR) 2005-0100297

(51) Int. Cl. H04Q 7/20

(52) U.S. Cl. 455/452.2

(57) ABSTRACT

A method and an apparatus for controlling call admission in an OFDM mobile communication system are provided. Upon receipt of a call admission request, it is determined whether a requested call is a handoff call or a new call and the traffic service type and QoS level of the requested call are determined. The amount of resources required for the call is calculated using the QoS level and the amount of resources of on-going calls is calculated according to the traffic service type. The amount of available resources in a cell is calculated using the amount of resources of the on-going calls and it is determined whether to admit the call by comparing the available resource amount with the required resource amount.

### PRIORITY

This application claims priority under 35 U.S.C. § 119 to an application filed in the Korean Intellectual Property Office on Oct. 24, 2005 and assigned Serial No. 2005-100297, the contents of which are incorporated herein by reference.

### BACKGROUND OF THE INVENTION

1. Field of the Invention

The present invention relates generally to an Orthogonal Frequency Division Multiplexing (OFDM) mobile communication system, and in particular, to an apparatus and method for controlling call admission.

2. Description of the Related Art

Along with the diversification of service types, broadband systems are attracting attention and technological development is behind the ever-increasing bandwidth. Yet, since spectrum resources are limited and the introduction of new broadband systems does not mean neglecting legacy systems, there is a need for a new technique to simultaneously support legacy systems operating in the existing bandwidths, as well as the new broadband systems.

Recently having gained prominence in broadband services, OFDM is a special case of Multi-Carrier Modulation (MCM). In OFDM, a serial symbol sequence is converted to parallel symbol sequences and modulated to mutually orthogonal subcarriers or subchannels, prior to transmission.

OFDM offers high frequency use efficiency due to transmission of data on orthogonal subcarriers and facilitates high-speed data processing by Fast Fourier Transform (FFT) and Inverse Fast Fourier Transform (IFFT). Also, the use of a cyclic prefix leads to robustness against multipath fading. As OFDM can be easily expanded to a Multiple-Input Multiple-Output (MIMO) scheme, it is under active study and is considered promising for 4^{th} Generation (4G) mobile communication systems and future-generation communications in general.

Orthogonal Frequency Division Multiple Access (OFDMA) is a multiple access scheme based on OFDM, in which part of the total subcarriers are allocated to a particular user. For OFDMA, dynamic resource allocation or frequency hopping is adopted to dynamically change a set of subcarriers allocated to a user according to the fading characteristics of a radio link. Therefore, OFDMA does not need a spreading sequence for spectrum spreading.

Although hardware complexity was an obstacle to the widespread use of OFDM, recent advances in digital signal processing technology, including FFT and IFFT, have enabled OFDM implementation. Accordingly, OFDM has been exploited in wide fields of digital data communications such as Digital Audio Broadcasting (DAB), digital television broadcasting, Wireless Local Area Network (WLAN), Wireless Asynchronous Transfer Mode (WATM), and Broadband Wireless Access (BWA).

To support broadband services, many OFDM-based frame structures have been designed. Most conventional frame structures were intended to provide a service in a new band allocated separately from an existing band. Moreover, as the increasing demand for frequency bands increases the cost of licensing them, deployment of broadband services is delayed despite the development of broadband technologies.

To solve the cost problem, a different approach (e.g. Code Division Multiple Access (CDMA) 2000 3× and scalable OFDM (S-OFDM)) has been taken to design a broadband system having an overlaid frequency band with a legacy system.

FIG. 1 illustrates the concept of resource allocation in a conventional S-OFDM system. Although any other duplexing scheme is available, the following description is made in the context of Time Division Duplexing (TDD).

Referring to FIG. 1, a preamble for time synchronization resides at the start of a frame, followed by symbols that provide control information containing a Base Station (BS) Identifier (ID) and other system information. Subsequently, MAP information is delivered to provide resource allocation information for each user, accompanied by user data on traffic subcarriers indicated by the MAP information. The traffic subcarriers are divided into Adaptive Modulation and Coding (AMC) subcarriers and diversity subcarriers, although it is obvious that any other traffic subcarriers may be used. For example, AMC subcarriers are allocated to a user experiencing little channel change in time, to thereby maximize transmission capacity, whereas diversity subcarriers are allocated to a user undergoing a rapid channel change over time, thus achieving a diversity gain.

Conventionally, a system has subcarriers and Frequency Allocation Blocks (FABs) each with a predetermined bandwidth defined by a predetermined number of subcarriers. As services are diversified and a required transmission capacity increases, the bandwidth will inevitably be increased. In this context, an Extended-Band BS (EB-BS) has been proposed. This EB-BS can be designed to overlay in frequency with an existing Narrow-Band BS (NB-BS).

Compared to the NB-BS, the EB-BS has the same bandwidth including existing FABs and existing subcarriers, but a different carrier. If an integer number of FABs of the NB-BS overlay with the frequency band of the EB-BS, the EB-BS may have the same carrier as the NB-BS. This EB-BS is considered for the following reasons.

(1) Reduction Of Frequency Bandwidth Licensing Cost.

As a frequency band is widened, the cost of licensing the bandwidth increases. In other words, if the frequency band is located with respect to other bands without being overlaid, licensing cost will increase to cover the bandwidth occupied by the new system. However, frequency band overlaying reduces the licensing cost for as much as the increment of frequency band.

(2) Increase Of Frequency Efficiency In An Overlaid Band.

Frequency efficiency is a critical factor to system performance. Since subscribers are charged in proportion to frequency efficiency, frequency efficiency is very significant to service providers. In case of frequency band overlaying, existing NB-BS users and EB-BS users share an overlaid band. This implies that more users are accommodated in effect and the frequency efficiency increases. In general, accommodating more users in a given band leads to a scheduling gain, i.e. multi-user diversity.

For the EB-BS, a total frequency band is divided into an integer number of FABs and users are serviced in overlapped FABs. For example, given four 20-MHz FABs, users communicate in 20-, 40-, and 80-MHz overlapped bands in the system.

FIG. 2 illustrates the concept of resource allocation in a conventional call admission control scheme. The call admission control scheme is based on a guard channel scheme which seeks to prevent disconnection of a handoff call by call admission control. According to the guard channel scheme, a dedicated fixed channel called a guard channel G-Cthr is reserved for a handoff call service from the total channel capacity G of the BS. If there is a channel shortage due to increased traffic, only the handoff call is admitted, with the admission of no more new calls. The other channels Cthr except for the guard channel G-Cthr are shared channels for the handoff call and the new call.

That is, a threshold Cthr is set for new call admission and the handoff call is treated with priority. If a current channel use rate is less than or equal to the threshold and a channel capacity required by the new call is available within the threshold, resources are allocated to the new call, thus admitting the new call. On the contrary, if the channel use rate exceeds the threshold, no resources are allocated to the new call, while only the handoff call from another cell occupies resources. Because disconnection of an on-going call is more irritating to users than rejection of a new call setup, the handoff call has priority and is placed before the new call.

The guard channel scheme is known to be very effective in ensuring a required Quality of Service (QoS) level for one type of service such as voice call. However, it has limitations in servicing a plurality of types of traffic. For example, if traffic with different channel bandwidth requirements co-exists, the call admission rate of traffic with a low channel bandwidth requirement is higher than that of traffic with a high channel bandwidth requirement in the guard channel scheme. As a consequence, the call admission control is rendered unfair.

FIG. 3 illustrates the concept of resource allocation in a call control scheme in a mobile communication system that provides a plurality of types of traffic services.

Referring to FIG. 3, admission of a handoff call and a new call is controlled basically based on the guard channel scheme, and more sources are reserved to voice communications with priority. That is, a bandwidth threshold (shared channel+K₃) is set for admission of a new voice call so that a handoff voice call of which the admissible bandwidth is shared channel+K₁ (K₁>K₃) is handled with priority relative to the new voice call. The shared channel is used to increase resource allocation rate and includes a predetermined number of channels from among a total number of channels C. The shared channel supports many types of traffic services according to their priority levels, including handoff voice call, new voice call, and hybrid data call. The traffic services are prioritized such that high-priority level traffic is admitted at high rate and low-priority level traffic is admitted at low rate. A typical traffic prioritization is given as follows.

TABLE 1

| | RTCS | RTSS | NRTS | BES |
|---|---|---|---|---|
| Priority | High | High | Low | Low |
| QoS parameter | Rate, Latency, | Rate, Latency, | Rate | — |
| | Jitter | Jitter | | |

Known as voice call, Real Time Conversational Service (RTCS) is sensitive to latency, jitter, and data rate. Thus, a required user QoS level for RTCS is high. Real Time Streaming Service (RTSS) is a voice or video streaming service provided to a user in real time by a service provider. Although it is sensitive to latency, jitter and data rate, RTSS is less sensitive to them than RTCS. Non Real Time Service (NRTS) is a non-real time data service. NRTS tolerates disconnection in time or latency but it requires a data rate to be kept at an acceptable level. Best Effort Service (BES) is one which does not provide full reliability. A major example of BES is Internet service. Under Internet service, dedicated use of a bandwidth for a particular user is prohibited, and therefore QoS is not ensured for that user. In general, real time service is higher in priority than non-real time service, and conversation service is higher in priority than streaming service.

Therefore, the hybrid data call (admissible bandwidth: shared channel+K₂) is lower in priority than the voice call. If the shared channel is used for the voice call, a bandwidth of K₂ is available to the hybrid data call.

However, the conventional guard channel scheme is highly likely to waste resources reserved for the guard channel because of inefficient use of limited resources. Also, if the call admission probability of lower-priority traffic is set to be very low, there is no chance even for the traffic. Hence, this is not a fair call admission control scheme.

### SUMMARY OF THE INVENTION

An object of the present invention is to substantially solve at least the above problems and/or disadvantages and to provide at least the advantages below. Accordingly, an object of the present invention is to provide an apparatus and method for controlling call admission in an OFDM mobile communication system.

Another object of the present invention is to provide an apparatus and method for controlling call admission to effectively deliver a plurality of types of traffic with different QoS levels to users in an OFDM mobile communication system.

A further object of the present invention is to provide an apparatus and method for controlling call admission to efficiently use time-frequency resources, while guaranteeing QoS in an OFDM mobile communication system.

According to one aspect of the present invention, in a method of controlling call admission in a mobile communication system, upon receipt of a call admission request, it is determined whether a requested call is a handoff call or a new call and the traffic service type and QoS level of the requested call are determined. The amount of resources required for the call is calculated using the Quality of Service (QoS) level and the amount of resources of on-going calls is calculated according to the traffic service type. The amount of available resources in a cell is calculated using the amount of resources of the on-going calls and it is determined whether to admit the call by comparing the available resource amount with the required resource amount.

According to another aspect of the present invention, in an apparatus for controlling call admission in a mobile communication system, a mobile station (MS) status detector determines, upon receipt of a call admission request message, whether a requested call is a handoff call or a new call and determines the traffic service type and Quality of Service (QoS) level of the requested call. A band measurer calculates the amount of resources required for the call using the QoS level and calculates the amount of resources of on-going calls according to the traffic service type. A call admission decider calculates the amount of available resources in a cell using the amount of resources of the on-going calls and determines whether to admit the call by comparing the available resource amount with the required resource amount.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the concept of resource allocation in a conventional S-OFDM system;

FIG. 2 illustrates the concept of resource allocation in a conventional call admission control scheme;

FIG. 3 illustrates the concept of a channel structure in a call control scheme in a conventional mobile communication system that provides a plurality of types of traffic services;

FIG. 4 illustrates the concept of resource allocation according to the present invention;

FIG. 5 is a block diagram of a call admission controlling apparatus in a BS in a mobile communication system according to the present invention;

FIG. 6 is a flowchart illustrating a call admission controlling scheme in the BS in the mobile communication system according to the present invention;

FIG. 7 is a flowchart illustrating a method of calculating the amount of resources required for a requested call in the mobile communication system according to the present invention;

FIG. 8 illustrates the concept of call admission control in a 10-MHz BS according to the present invention;

FIG. 9 illustrates the concept of call admission control in a 20-MHz BS according to the present invention;

FIG. 10 illustrates the concept of call admission control in a 40-MHz BS according to the present invention; and

FIG. 11 illustrates the concept of call admission control in an 80-MHz BS according to the present invention.

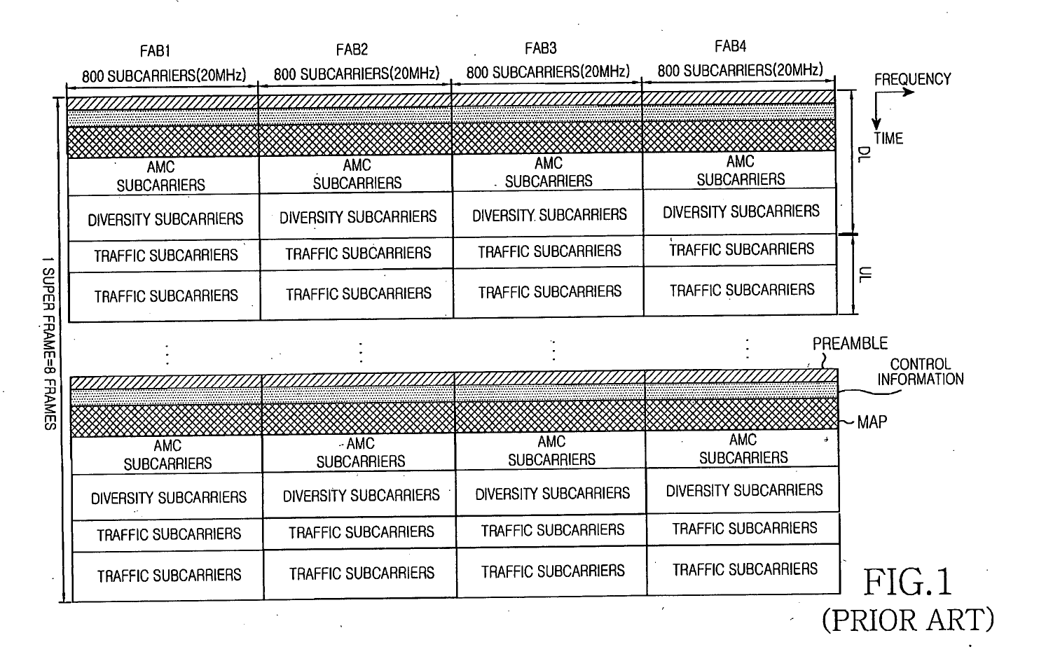

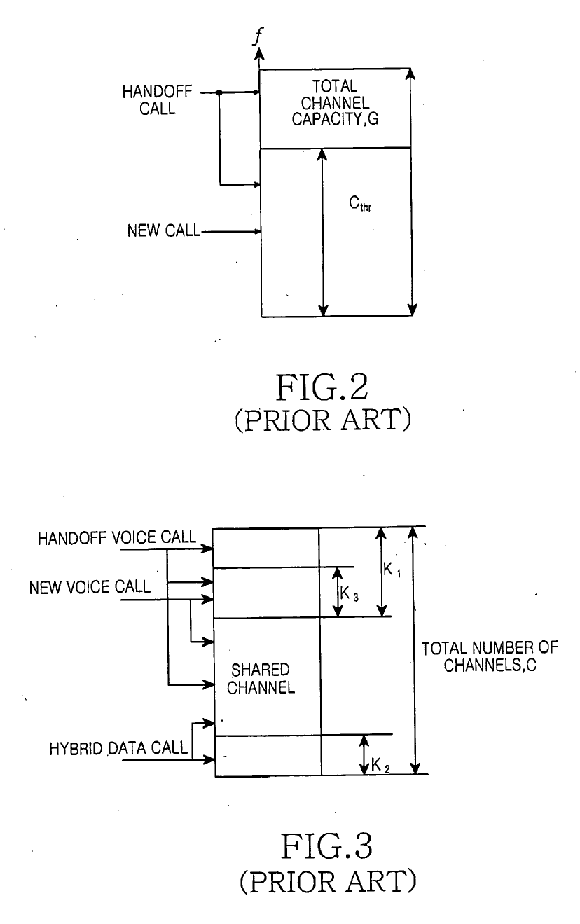

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an apparatus and method for controlling call admission in an OFDM mobile communication system.

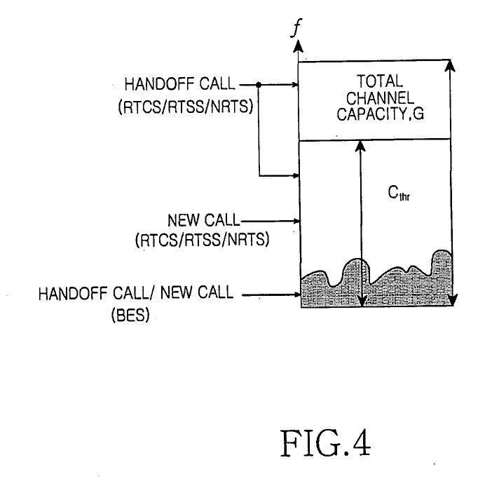

FIG. 4 illustrates the concept of resource allocation in a BS according to the present invention.

Referring to FIG. 4, the BS allocates resources basically in a guard channel scheme. According to the present invention, a different call admission condition is applied depending on the type of a requested call and the type of traffic associated with the call.

When a k^{th} user requests a traffic service m, the amount of resources (i.e. bandwidth) required for the traffic service m is computed by Equation (1):
ƒ_{k,m}=r_{k,m}+α(QoS_{k,m})·σ_{k,m}² (1)
where r_{k,m} denotes an average occupied bandwidth and σ²_{k,m} denotes the deviation of user traffic, which is a fixed value. α(QoS_{k,m}) is a QoS function proportional to QoS, and QoS_{k,m} is determined by a data rate, jitter, latency, etc. A greater QoS (>1) leads to a larger deviation of the traffic service. Thus, α(QoS_{k,m}) ensures a required bandwidth, for stable service. If α(QoS_{k,m}) affects the average occupied bandwidth, not the deviation, the service itself may be impossible. Hence, it is more reasonable that α(QoS_{k,m}) affects the deviation factor rather than the average factor.

When the computed bandwidth requirement of the data service of the user meets the following handoff/new call admission condition, the call is admitted as illustrated in FIG. 4.

If the traffic service m for the k^{th} user is a handoff call, the handoff call admission condition is given as Equation (2):
G−C_{P}_{ᵢ}_{≧P}_{ₖ}^{Σmax}−C_{P}_{ᵢ}_{<P}_{ₖ}^{Σmin}≧ƒ_{k,m} (2)
where G denotes the total number of channels available to users in a cell. According to Equation (2), if the remainder of subtracting the bandwidths of on-going services from the total number of channels G is greater than or equal to ƒ_{k,m}, the handoff call is admitted. i and k are variables denoting users and Pᵢ and Pₖ represent the priority levels of an i^{th} user and the k^{th} user, respectively. Thus, Pᵢ≧Pₖ means that the priority level of the i^{th} user is greater than or equal to that of the k^{th} user, and Pᵢ<Pₖ means that the priority level of the i^{th} user is lower than that of the k^{th} user. C_{P}_{ᵢ}_{≧P}_{ₖ}^{Σmax} represents a maximum bandwidth that calls with priority levels greater than or equal to that of the call of the k^{th} user can occupy with respect to the bandwidth of the on-going services in the cell. That is, C_{P}_{ᵢ}_{≧P}_{ₖ}^{Σmax} means a bandwidth ensuring a full QoS. C_{P}_{ᵢ}_{<P}_{ₖ}^{Σmin} represents a minimum bandwidth that calls with lower priority levels than the call of the k^{th} user can occupy with respect to the bandwidth of the on-going services in the cell. That is, C_{P}_{ᵢ}_{<P}_{ₖ}^{Σmin} means a bandwidth ensuring a minimized QoS in Equation (1).

If the traffic service m for the k^{th} user is a new call, the new call admission condition is given as Equation (3):
Cₜₕᵣ−C^{Σmax}≧ƒ_{k,m} (3)
where Cₜₕᵣ represents a bandwidth threshold for admitting the new call and C^{Σmax} represents the bandwidth that the on-going calls occupy in the cell, i.e. the maximum bandwidth ensuring the full QoS of the on-going calls as calculated by Equation (1). This implies that the new call is admitted as long as it does not restrict the QoS of the on-going calls.

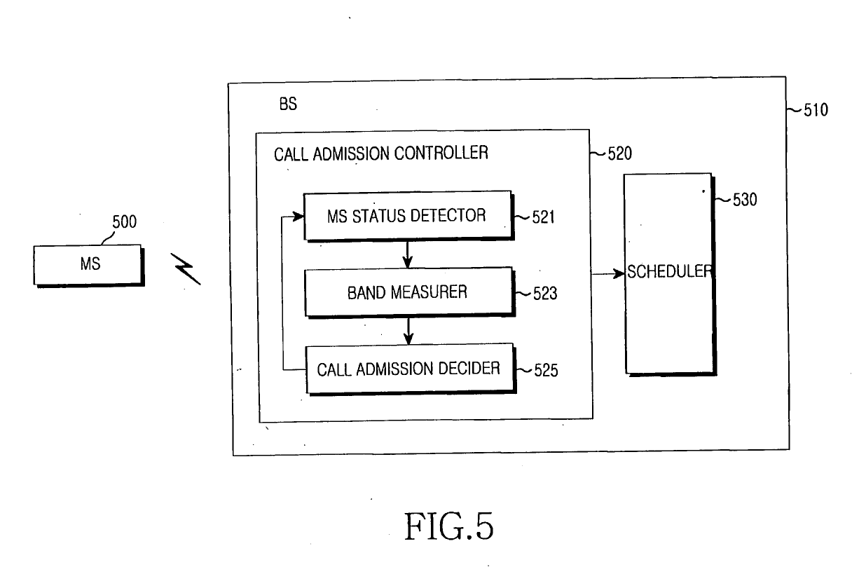

FIG. 5 is a block diagram of a call admission controlling apparatus in a BS in a mobile communication system according to the present invention. A BS 510 includes a call admission controller 520 and a scheduler 530. The call admission controller 520 is comprised of a Mobile Station (MS) status detector 521, a band measurer 523, and a call admission decider 525.

Referring to FIG. 5, the MS status detector, which is a detector means, 521 receives a call admission request message from an MS 500 and determines whether a call requested by the MS 500 is a handoff call or a new call. The MS status detector 521 also detects the traffic service type of the requested call and the QoS level of the traffic service. The call admission request message includes an average occupied bandwidth, the deviation of user traffic, and QoS information with a data rate, jitter, and latency. The MS status detector 521 stores the QoS level, average and deviation of the traffic in a memory (not shown). It also stores a list of admitted calls and their status information. The MS status detector 521 outputs the QoS level of the requested call and the average and deviation of the traffic to the band measurer 523. The QoS level varies with the traffic service type and the required bandwidth increases with the QoS level.

The band measurer 523 calculates the bandwidth requirement using the QoS level, average and deviation of the traffic by Equation (1) and provides the calculated bandwidth to the call admission decider 525. The call admission decider 525 determines whether to admit the call according to the call admission condition expressed as Equation (2) or (3) and provides the determined call admission information. The MS status detector 521 updates the list of admitted calls with the call admission information and notifies the scheduler 530 of the updated list and the statuses of the calls.

Here, the band measurer 523 and the call admission decider 525 can collectively be referred as a call admission deciding means.

The scheduler 530 schedules the admitted calls using the same QoS level.

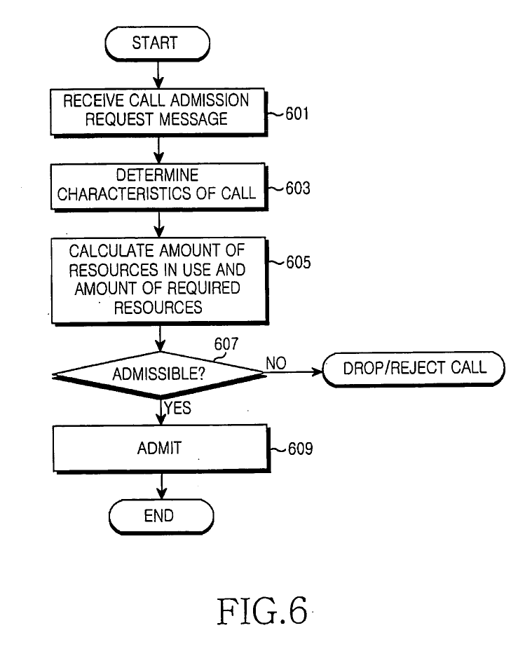

FIG. 6 is a flowchart illustrating a call admission controlling scheme in the BS in the mobile communication system according to the present invention.

Referring to FIG. 6, in the BS 510, the call admission controller 520 receives a call admission request message from the MS 500 in step 601. The call admission request message contains variables depicted in Equation (1), i.e. the average occupied bandwidth r_{k,m}, the deviation of user traffic σ²_{k,m}, and the QoS information QoS_{k,m} including a data rate, jitter and latency. In an Institute of Electrical and Electronics Engineers (IEEE) 802.16 system, for example, a Dynamic Service Addition/Change Request (DSA/DSC-REQ) message is equivalent to the call admission request message. In this case, the information can be carried in the form of Type/Length/Value (TLV).

In step 603, the call admission controller 520 detects the characteristics of a call requested (the requested call type) by the MS 500 from the received message. Specifically, it determines whether the call is a new call created in the cell or a handoff call from another cell, detects the traffic service type and QoS level of the call and the average and deviation of the traffic, and stores the detected information in the memory. The traffic service type can be RTCS, RTSS, NRTS, or BES.

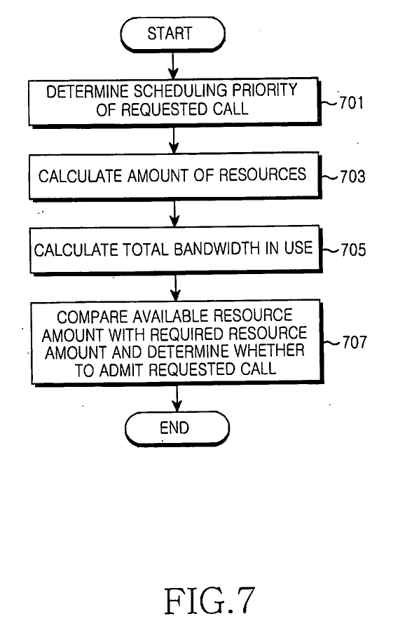

The call admission controller 520 calculates the amount of resources in current use in the cell and the amount of resources required for the call using the detected information in step 605. How the resource amount is calculated will be described later in detail with reference to FIG. 7.

In step 607, the call admission controller 520 determines whether to admit the requested call according to the call admission condition of the present invention. The determination is made by checking whether the amount of resources required for the call is acceptable with respect to the available resources of the cell. If the required resources are greater than the available resources of the cell, that is, if the call is not admissible, the call admission controller 520 drops/rejects the call in step 611. If the requested call is a handoff call, the call is dropped and if the requested call is a new call, the call is rejected. On the other hand, if the required resources are less than the available resources of the cell, that is, if the call is admissible, the call admission controller 520 admits the call in step 609. Simultaneously, the call admission controller 520 updates the list of admitted calls by adding information about the admitted call to the information of the already admitted calls, for use in the next call admission control. It can output the updated call list and information of the calls to the scheduler 530. Then the call admission controller 520 ends the process of the present invention.

FIG. 7 is a flowchart illustrating a method of calculating the amount of resources required for the requested call in the mobile communication system according to the present invention.

Referring to FIG. 7, the call admission controller 520 determines the scheduling priority of the requested call according to its traffic service type in step 701. The traffic service type can be RTCS, RTSS, NRTS, or BES. Typically, real time service is higher than non-real time service in priority, and conversational service is higher than streaming service in priority.

In step 703, the call admission controller 520 calculates the amount of resources ƒ_{k,m} required to admit the call according to its QoS level by Equation (1). If the requested call is a handoff call, a is set to a maximum value in Equation (1) so as to maximize the bandwidth of the call (Bmax). If the requested call is a new call, α is set to a minimum value in Equation (1) so as to minimize the bandwidth of the call (Bmin).

The call admission controller 520 calculates the total bandwidth in current use in the cell according to the traffic service type in step 705.

In the case of a handoff call, the call admission controller 520 compares on-going calls with the handoff call in terms of priority level and calculates the total bandwidth in current use according to the priority levels as follows.

TABLE 2

| | RTCS/RTSS | | NRTS |
|---|---|---|---|
| Pᵢ ≧ Pₖ | C_{P}_{ᵢ}_{≧P}_{ₖ}^{Σmax} | Pᵢ < Pₖ | C_{P}_{ᵢ}_{>P}_{ₖ}^{Σmax} |
| Pᵢ < Pₖ | C_{P}_{ᵢ}_{<P}_{ₖ}^{Σmax} | Pᵢ ≦ Pₖ | C_{P}_{ᵢ}_{≦P}_{ₖ}^{Σmax} |

If the handoff call is RTCS or RTSS, the bandwidths of on-going calls greater than or equal to the handoff call in priority level (Pᵢ≧Pₖ) are maximized, and the bandwidths of on-going calls lower than the handoff call in priority level (Pᵢ<Pₖ) are restricted to the minimum. As a consequence, a sufficient bandwidth is ensured for the handoff call and the QoS level requested by the MS is met. If the handoff call is NRTS, the bandwidths of on-going RTCS and RTSS calls higher than the handoff call in priority level (Pᵢ>Pₖ) are maximized, and the bandwidths of on-going calls less than or equal to the handoff call in priority level (Pᵢ≦Pₖ) are restricted to the minimum.

If the requested call is a new call, the call admission controller 520 calculates the total bandwidth occupied for on-going calls using their information. Because the new call does not affect the QoS of the on-going calls, the amount of resources in use in the cell is calculated irrespective of the traffic service type of the new call such that even the QoS levels of calls lower than that of the new call are fully satisfied, that is, a maximum bandwidth is guaranteed for the on-going calls.

In step 707, the call admission controller 520 calculates the amount of available resources in the cell based on the amount of resources in current use, compares the available resource amount with the required resource amount, and determines whether to admit the requested call by Equation (2) or (3). If the requested call is a handoff call, the call admission controller 520 calculates the available resource amount by subtracting the resource amount in current use from the total number of channels. If the requested call is a new call, the call admission controller 520 calculates the available resource amount by subtracting the resource amount in current use from a bandwidth threshold for accepting the new call. If the available resource amount is less than or equal to the requested resource amount, the call admission controller 520 drops or rejects the requested call. Then the call admission controller 520 ends the process of the present invention.

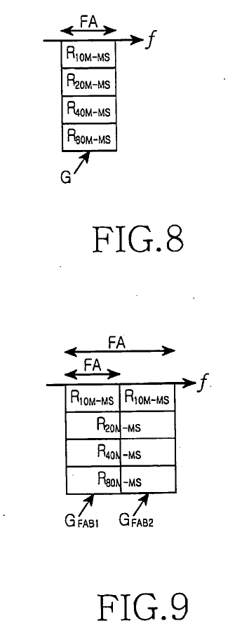

FIGS. 8 to 11 illustrate the concepts of call admission control in BSs with different bandwidths according to embodiments of the present invention. The following description is made under the assumption that four types of MSs with 10-MHz Frequency Allocation (FA), 20-MHz FA, 40-MHz FA, and 80-MHz FA exist in each cell.

FIG. 8 illustrates the concept of call admission control in a 10-MHz BS according to the present invention.

Referring to FIG. 8, even if the four types of MSs can extend their FAs, only a 10-MHz PA is available because the BS's FA is 10 MHz. The 10-MHz BS determines whether to admit a handoff call or a new call according to the traffic service type of the call based on the following call admission conditions.

If the traffic service type is RTCS, the handoff call and new call admission conditions are given as Equations (4) and (5):
G−C_{P}_{ᵢ}_{≧P}_{ₖ}_{,RTCS}^{Σmax}−C_{P}_{ᵢ}_{<P}_{ₖ}_{,RTCS}^{Σmin}≧ƒ_{k,RTCS} (4)
Cₜₕᵣ−C^{Σmax}≧ƒ_{k,RTCS} (5)

If the traffic type is RTSS, the handoff call and new call admission conditions are given as Equations (6) and (7):
G−C_{P}_{ᵢ}_{≧P}_{ₖ}_{,RTSS}^{Σmax}−C_{P}_{ᵢ}_{<P}_{ₖ}_{,RTSS}^{Σmin}≧ƒ_{k,RTSS} (6)
Cₜₕᵣ−C^{Σmax}≧ƒ_{k,RTSS} (7)

If the traffic type is NRTS, the handoff call and new call admission conditions are given as Equations (8) and (9):
G−C_{P}_{ᵢ}_{>P}_{ₖ}_{,NRTS}^{Σmax}−C_{P}_{ᵢ}_{≦P}_{ₖ}_{,NRTS}^{Σmin}≧ƒ_{k,NRTS} (8)
Cₜₕᵣ−C^{Σmax}≧ƒ_{k,NRTS} (9)

If the traffic type is BES, the handoff call and new call admission condition is given as Equation (10):
Cₜₕᵣ−C^{Σmax}≧ƒ_{k,BES} (10)

FIG. 9 illustrates the concept of call admission control in a 20-MHz BS according to the present invention.

Referring to FIG. 9, the MS with the 20-MHz FA can select the total band. However, because the BS's FA is 20 MHz, the MSs with the 40-MHz FA and the 80-MHz FA are restricted to 20 MHz even if they can extend their FAs. The 10-MHz MS can select one of two FABs. Compared to the 10-MHz cell illustrated in FIG. 8, a plurality of FABs can be defined in the 20-MHz cell. Hence, the FABs can be used for flexible call admission control. The bandwidth threshold for the 20-MHz BS is computed by Equation (11):
Cₜₕᵣ=C_{thr,FAB1}+C_{thr,FAB2} (11)

The BS may admit a handoff call mainly in FAB1 and a new call mainly in FAB2. Alternatively, the BS may admit RTCS and RTSS users in FAB1 and NRTS and BES users in FAB2. For RTCS, the handoff call and new call admission conditions are given as follows.

If the MS with the 10-MHz FA is admitted in FAB1, the handoff call and new call admission conditions are expressed as Equations (12) and (13):
G_{FAB1}−C_{P}_{ᵢ}_{≧P}_{ₖ}_{,RTCS,FAB1}^{Σmax}−C_{P}_{ᵢ}_{<P}_{ₖ}_{,RTCS,FAB1}^{Σmin}≧ƒ_{k,RTCS} (12)
C_{thr,FAB1}−C_{FAB1}^{Σmax}≧ƒ_{k,RTCS} (13)

If the 20-MHz, 40-MHz, and 80-MHz MSs are admitted in FAB1 and FAB2, the handoff call and new call admission conditions are expressed as Equations (14) and (15):
(G_{FAB1}+G_{FAB2})−(C_{P}_{ᵢ}_{≧P}_{ₖ}_{,RTCS,FAB1}^{Σmax}+C_{P}_{ᵢ}_{≧P}_{ₖ}_{,RTCS,FAB2}^{Σmax})−(C_{P}_{ᵢ}_{<P}_{ₖ}_{,RTCS,FAB1}^{Σmin}+C_{P}_{ᵢ}_{<P}_{ₖ}_{,RTCS,FAB2}^{Σmin})≧ƒ_{k,RTCS} (14)
(C_{thr,FAB1}+C_{thr,FAB2})−(C_{FAB1}^{Σmax}+C_{FAB2}^{Σmax})≧ƒ_{k,RTCS} (15)

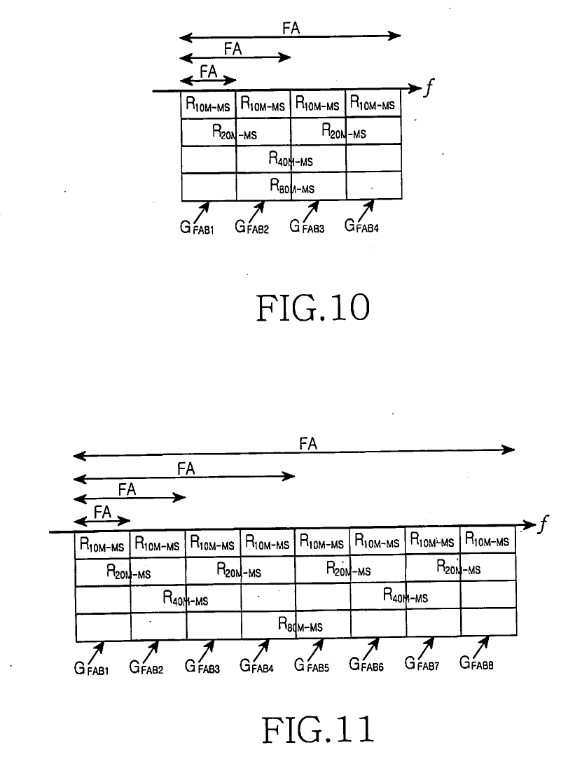

FIG. 10 illustrates the concept of call admission control in a 40-MHz BS according to the present invention.

Referring to FIG. 10, because the BS has an FA of 40 MHz, the MS with the 80-MHz FA is restricted to 40 MHz even if it can extend its FA. The 10-MHz MS can select one of four FABs and the 20-MHz MS can select two of the four FABs. Since a plurality of FABs can be defined in the 40-MHz cell, the FABs can be used for flexible call admission control. The bandwidth threshold for the 40-MHz BS is computed by Equation (16):
Cₜₕᵣ=C_{thr,FAB1}+C_{thr,FAB2}+C_{thr,FAB3}+C_{thr,FAB4} (16)

The BS may admit a handoff call mainly in FAB1 and FAB2 and a new call mainly in FAB3 and FAB4. Alternatively, the BS may admit RTCS and RTSS users in FAB1 and FAB2 and NRTS and BES users in FAB3 and FAB4. For RTCS, the handoff call and new call admission conditions are given as follows.

If the MS with the 10-MHz FA is admitted in FAB1, the handoff call and new call admission conditions depicted in Equation (12) and Equation (13) are applied. If the MS with the 20-MHz FA is admitted in FAB1 and FAB2, the handoff call and new call admission conditions depicted in Equation (14) and Equation (15) are applied. If the MSs with the 40-MHz FA and the 80-MHz FA are admitted in FAB1 to FAB4, the handoff call and new call admission conditions are given as Equations (17) and (18):
(G_{FAB1}+ . . . +G_{FAB4})−(C_{P}_{ᵢ}_{≧P}_{ₖ}_{,RTCS,FAB1}^{Σmax}+ . . . +C_{P}_{ᵢ}_{≧P}_{ₖ}_{,RTCS,FAB4}^{Σmax}) −(C_{P}_{ᵢ}_{<P}_{ₖ}_{,RTCS,FAB1}^{Σmin}+ . . . +C_{P}_{ᵢ}_{<P}_{ₖ}_{,RTCS,FAB4}^{Σmin})≧ƒ_{k,RTCS} (17)
(C_{thr,FAB1}+C_{thr,FAB2}+C_{thr,FAB3}+C_{thr,FAB4})−(C_{FAB1}^{Σmax}+C_{FAB2}^{Σmax}+C_{FAB3}^{Σmax}+C_{FAB4}^{Σmax})≧ƒ_{k,RTCS} (18)

FIG. 11 illustrates the concept of call admission control in an 80-MHz BS according to the present invention.

Referring to FIG. 11, the 10-MHz MS can select one of eight FABs, the 20-MHz MS can select two of the eight FABs, and the 40-MHz MS can select four of the eight FABs. The 80-MHz MS can select the total band. Since a plurality of FABs can be defined in the 80-MHz cell, the FABs can be used for flexible call admission control. The bandwidth threshold for the 80-MHz BS is computed by Equation (19):
Cₜₕᵣ=C_{thr,FAB1}+C_{thr,FAB2}+ . . . +C_{thr,FAB3} (19)

For RTCS, the handoff call and new call admission conditions are given as follows.

If the MS with the 10-MHz FA is admitted in FAB1, the handoff call and new call admission conditions depicted in Equation (12) and Equation (13) are applied. If the MS with the 20-MHz FA is admitted in FAB1 and FAB2, the handoff call and new call admission conditions depicted in Equation (14) and Equation (15) are applied. If the MSs with the 40-MHz FA and the 80-MHz FA are admitted in FAB1 to FAB4, the handoff call and new call admission conditions depicted in Equation (17) and Equation (18) are applied. If the MS with the 80-MHz FA is admitted in FAB1 to FAB8, the handoff call and new call admission conditions are given as Equations (20) and (21):
(G_{FAB1}+ . . . +G_{FAB8})−(C_{P}_{ᵢ}_{≧P}_{ₖ}_{,RTCS,FAB1}^{Σmax}+ . . . +C_{P}_{ᵢ}_{≧P}_{ₖ}_{,RTCS,FAB8}^{Σmax}) −(C_{P}_{ᵢ}_{<P}_{ₖ}_{,RTCS,FAB1}^{Σmin}+ . . . +C_{P}_{ᵢ}_{<P}_{ₖ}_{,RTCS,FAB8}^{Σmin})≧ƒ_{k,RTCS} (20)
(C_{thr,FAB1}+ . . . +C_{thr,FAB8})−(C_{FAB1}^{Σmax}+ . . . +C_{FAB8}^{Σmax})≧ƒ_{k,RTCS} (21)

In accordance with the present invention as described above, the call admission controlling apparatus and method use different call admission conditions according to call type and traffic type in an OFDM mobile communication system. Therefore, call admission is controlled such that limited resources are efficiently utilized for different traffic services and user QoS is satisfied. In an S-OFDMA system, call admission is flexibly controlled on an FA basis according to call type and traffic type. In a frequency-overlapped S-OFDMA system, call admission is flexibly controlled by allocating calls for users having different FAs to FABs. Also, since continuously updated information about calls admitted with a QoS guarantee is provided to a scheduler, scheduling effect is maximized.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of controlling call admission in a mobile communication system, comprising the steps of:
determining whether a requested call is a handoff call or a new call and determining a traffic service type and Quality of Service (QoS) level of the requested call;
calculating the amount of resources required for the call using the QoS level and calculating the amount of resources of on-going calls according to the traffic service type; and
calculating the amount of available resources in a cell and determining whether to admit the call by comparing the available resource amount with the required resource amount.

2. The method of claim l, wherein the traffic service type is one or Real Time Conversational Service (RTCS), Real Time Streaming Service (RTSS), Non Real Time Service (NRTS), and Best Effort Service (BES).

3. The method of claim 1, wherein the step of calculating the amount of resources required for the call comprises calculating the required resource amount is by
ƒ_{k,m}=r_{k,m}+α(QoS_{k,m})·σ_{k,m}²
where ƒ_{k,m} denotes the amount of resources required for a traffic service m requested by a k^{th} user, r_{k,m} denotes an average occupied bandwidth, σ²_{k,m} denotes the deviation of user traffic, and α(QoS_{k,m}) is a QoS function proportional to QoS, α being set to a maximum value for a handoff call and to a minimum value for a new call.

4. The method of claim 1, wherein if the requested call is a handoff call, the step of calculating the amount of resources of on-going calls comprises calculating the amount of resources of the on-going calls using priority levels of the on-going calls and a priority level of the requested call, the priority levels being determined by the traffic service types of the calls.

5. The method of claim 4, wherein if the requested call is a handoff call and the traffic service type is real-time service, the step of calculating the amount of resources of on-going calls comprises calculating the amount of resources of the on-going calls by
C_{P}_{ᵢ}_{≧P}_{ₖ}^{Σmax}+C_{P}_{ᵢ}_{<P}_{ₖ}^{Σmin}
where i and k are variables denoting users, Pᵢ and Pₖ represent the priority levels of an i^{th} user and the k^{th} user, respectively, C_{P}_{ᵢ}_{≧P}_{ₖ}^{Σmax} represents a maximum bandwidth that calls with priority levels greater than or equal to that of a call of the k^{th} user can occupy, and C_{P}_{ᵢ}_{<P}_{ₖ}^{Σmin} represents a minimum bandwidth that calls with lower priority levels than the call of the k^{th} user can occupy.

6. The method of claim 4, wherein if the requested call is a handoff call and the traffic service type is non-real-time service, the step of calculating the amount of resources of on-going calls comprises calculating the amount of resources of the on-going calls by
C_{P}_{ᵢ}_{>P}_{ₖ}^{Σmax}+C_{P}_{ᵢ}_{≦P}_{ₖ}^{Σmin}
where i and k are variables denoting users, Pᵢ and Pₖ represent the priority levels of the i^{th} user and the k^{th} user, respectively, C_{P}_{ᵢ}_{>P}_{ₖ}^{Σmax} represents a maximum bandwidth that calls with priority levels higher than that of the call of the k^{th} user can occupy, and C_{P}_{ᵢ}_{<P}_{ₖ}^{Σmin} represents a minimum bandwidth that calls with priority levels less than or equal to the call of the k^{th} user can occupy.

7. The method of claim 1, wherein if the requested call is a new call or the traffic service type is BES, the step of calculating the amount of resources of on-going calls comprises the step of calculating the amount of resources of the on-going calls by
C^{Σmax}
which is a maximum bandwidth for the on-going calls.

8. The method of claim 1, wherein if the requested call is a new call and the traffic service type is real-time service or no-real-time service, the step of calculating the amount of available resources in a cell comprises calculating the available resource amount by subtracting the amount of resources of the on-going calls from a threshold set for admitting a new call.

9. The method of claim 1, wherein if the requested call is a new call and the traffic service type is BES, or if the requested call is a handoff call, the step of calculating the amount of available resources in a cell comprises calculating the available resource amount by subtracting the amount of resources of the on-going calls from a total channel capacity.

10. The method of claim 1, wherein the step of determining whether to admit the call comprises determining to admit the call if the available resource amount is greater than or equal to the required resource amount.

11. The method of claim 1, wherein the QoS level is determined by at least one of data rate, jitter and latency.

12. The method of claim 1, wherein the system includes a Mobile Station (MS) with a Frequency Allocation (FA) of a predetermined frequency bandwidth and a total bandwidth of the system is divided into a predetermined number of Frequency Allocation Blocks (FABs).

13. The method of claim 12, wherein if the FA of the MS is narrower than the total bandwidth of the system, FABs satisfying the FA of the MS are allocated to the MS, and if the FA of the MS is wider than or equal to the total bandwidth of the system, the predetermined number of FABs are allocated to the MS.

14. The method of claim 13, wherein the total channel capacity, the bandwidth threshold, and the amount of resources of the on-going calls are calculated for an MS to which a plurality of FABs are allocated by respectively summing the total channel capacities, bandwidth thresholds, and amounts of resources of on-going calls of the FABs.

15. The method of claim 14, wherein the total channel capacity for an MS to which n FABs are allocated is
G_{FAB1}+ . . . +G_{FABn}G

16. The method of claim 15, wherein the bandwidth threshold for the MS to which the n FABs are allocated is
C_{thr,FAB1}+ . . . +C_{thr,FABn}

17. The method of claim 15, wherein if the requested call of the MS to which the n FABs are allocated is a handoff call and the traffic service type is real-time service, the step of calculating the amount of resources of on-going calls comprises calculating the amount of resources of the on-going calls by
(C_{P}_{ᵢ}_{≧P}_{ₖ}_{,FAB1}^{Σmax}+ . . . +C_{P}_{ᵢ}_{≧P}_{ₖ}_{,FABn}^{Σmax})+(C_{P}_{ᵢ}_{<P}_{ₖ}_{,FAB1}^{Σmin}+ . . . +C_{P}_{ᵢ}_{<P}_{ₖ}_{,FABn}^{Σmin})
where i and k are variables denoting users, Pᵢ and Pₖ represent the priority levels of the i^{th} user and the k^{th} user, respectively, C_{P}_{ᵢ}_{≧P}_{ₖ}^{Σmax} represents a maximum bandwidth that calls with priority levels greater than or equal to that of a call of the k^{th} user can occupy, and C_{P}_{ᵢ}_{<P}_{ₖ}^{Σmin} represents a minimum bandwidth that calls with lower priority levels than the call of the k^{th} user can occupy.

18. The method of claim 15, wherein if the requested call of the MS to which the n FABs are allocated is a handoff call and the traffic service type is non-real-time service, the step of calculating the amount of resources of on-going calls comprises calculating the amount of resources of the on-going calls by
(C_{P}_{ᵢ}_{>P}_{ₖ}_{,FAB1}^{Σmax}+ . . . +C_{P}_{ᵢ}_{>P}_{ₖ}_{,FABn}^{Σmax})+(C_{P}_{ᵢ}_{≦P}_{ₖ}_{,FAB1}^{Σmin}+ . . . +C_{P}_{ᵢ}_{≦P}_{ₖ}_{,FABn}^{Σmin})
where i and k are variables denoting users, Pᵢ and Pₖ represent the priority levels of the i^{th} user and the k^{th} user, respectively, C_{P}_{ᵢ}_{>P}_{ₖ}^{Σmax} represents a maximum bandwidth that calls with priority levels higher than that of the call of the k^{th} user can occupy, and C_{P}_{ᵢ}_{<P}_{ₖ}^{Σmin} represents a minimum bandwidth that calls with priority levels less than or equal to the call of the k^{th} user can occupy.

19. The method of claim 15, wherein if the requested call of the MS to which the n FABs are allocated is a new call or the traffic service type is BES, the step of calculating the amount of resources of on-going calls comprises calculating the amount of resources of the on-going calls by
(C_{FAB1}^{Σmax}+ . . . +C_{FABn}^{Σmax})
where C^{Σmax} is a maximum bandwidth for the on-going calls.

20. The method of claim 1, wherein call admission is controlled based on a guard channel scheme.

21. The method of claim 1, further comprising updating a list of the on-going calls using information about an admitted call and outputting the updated list to a scheduler.

22. An apparatus for controlling call admission in a mobile communication system, comprising:
a Mobile Station (MS) status detector for determining whether a requested call is a handoff call or a new call and determining a traffic service type and Quality of Service (QoS) level of the requested call;
a band measurer for calculating the amount of resources required for the call using the QoS level and calculating the amount of resources of on-going calls according to the traffic service type; and
a call admission decider for calculating the amount of available resources in a cell and determining whether to admit the call by comparing the available resource amount with the required resource amount.

23. The apparatus of claim 22, further comprising a memory for storing a list of admitted calls and information about the admitted calls, updating the list using information about an admitted call received from the call admission decider, and outputting the updated list and information about the calls to a scheduler.

24. The apparatus of claim 22, wherein the traffic service type is one of Real Time Conversational Service (RTCS), Real Time Streaming Service (RTSS), Non Real Time Service (NRTS), and Best Effort Service (BES).

25. The apparatus of claim 22, wherein the QoS level is determined by at least one of data rate, jitter and latency.

26. The apparatus of claim 22, wherein the band measurer calculates the required resource amount by
ƒ_{k,m}=r_{k,m}+α(QoS_{k,m})·σ_{k,m}²
where ƒ_{k,m} denotes the amount of resources required for a traffic service m requested by a k^{th} user, r_{k,m} denotes an average occupied bandwidth, σ²_{k,m} denotes the deviation of user traffic, and α(QoS_{k,m}) is a QoS function proportional to QoS, α being set to a maximum value for a handoff call and to a minimum value for a new call.

27. The apparatus of claim 22, wherein call admission is controlled based on a guard channel scheme.

28. The apparatus of claim 22, wherein the call admission request message includes at least one of the average occupied bandwidth, the deviation of user traffic, and the QoS level.

29. A method of controlling call admission in a mobile communication system, comprising the steps of:
identifying a requested call type, a traffic service type and Quality of Service (QoS) level of a requested call;
calculating the amount of resources required for the call using the QoS level;
calculating the amount of available resource by calculating the amount of resources of on-going calls according to the requested call type and the traffic service type; and
determining whether to admit the requested call by comparing the available resource amount with the required resource amount.

30. The method of claim 29, wherein the requested call type is one of a handoff call or a new call.

31. An apparatus for controlling call admission in a mobile communication system, comprising:
a detector means for identifying a requested call type, a traffic service type and Quality of Service (QoS) level of a requested call;
a call admission deciding means for calculating the amount of available resource by calculating the amount of resources of on-going calls according to the requested call type and the traffic service type, and determining whether to admit the requested call by comparing the available resource amount with the required resource amount.

32. The method of claim 31, wherein the requested call type is one of a handoff call or a new call.
